(19) United States
(12) Patent Application Publication
(10) Pub. No.: US 2026/0077568 A1
(43) Pub. Date: Mar. 19, 2026

(54) CAPILLARY DEVICE AND FORMATION METHOD THEREOF

(71) Applicant: Delta Electronics, Inc., Taoyuan City (TW)

(72) Inventors: Wen-Shiang CHEN, Taoyuan City (TW); Chih-Wei CHAN, Taoyuan City (TW)

(21) Appl. No.: 19/242,062

(22) Filed: Jun. 18, 2025

Related U.S. Application Data
(60) Provisional application No. 63/695,066, filed on Sep. 16, 2024.

(30) Foreign Application Priority Data
Dec. 5, 2024 (CN) 202411777675.7

(51) Int. Cl. B32B 7/12; B32B 5/18

(52) U.S. Cl. CPC B32B 7/12; B32B 5/18; B32B 2250/04; B32B 2266/045

(57) ABSTRACT

A capillary device and a formation method thereof are provided. The capillary device includes a first element, a second element, and a connecting structure. The first element includes a first supporting layer and a first capillary structure disposed on the first supporting layer and including a first metal material. The second element includes a second supporting layer and a second capillary structure disposed on the second supporting layer and including a second metal material. The connecting structure is disposed on the interface between the first capillary structure and the second capillary structure. The connecting structure connects the first capillary structure and the second capillary structure. The connecting structure includes a connecting material that is different from the first metal material and the second metal material.

### CROSS REFERENCE TO RELATED APPLICATIONS

This application claims the benefit of U.S. Provisional Application No. 63/695,066, filed Sep. 16, 2024, and claims priority of China Patent Application No. 202411777675.7, filed on Dec. 5, 2024, the entirety of which is incorporated by reference herein.

### TECHNICAL FIELD

Some embodiments of the present disclosure relate to a capillary device and a formation method thereof, and, in particular, to the capillary device including a connecting structure and a formation method thereof.

### BACKGROUND

In order to adjust the flow direction of a channel having a capillary function, the capillary structures in different elements need to be connected to each other. In general, a strong external force may be applied to make the capillary structures in different elements come into direct contact, press together tightly, or engage with each other.

However, since the capillary structure itself is a rigid structure, it is difficult for it to be directly bonded effectively. For example, in a capillary device formed by direct bonding, the contact interface between different capillary structures may have pores, discontinuous surfaces, deformation, or even be difficult to bond, which may result in an inability to effectively conduct the working fluid, thereby causing the effectivity of the entire capillary device to be poor.

Therefore, although existing capillary devices and formation methods thereof have gradually met their intended uses, they still do not fully meet the requirements in all respects. Therefore, there are still some problems to be overcome regarding capillary devices and the formation methods thereof.

### SUMMARY

The present disclosure disposes a connecting structure on the interface between the first capillary structure and the second capillary structure to avoid problems such as pores, discontinuous surfaces, and deformation at the interface between the capillary structures. Therefore, the working fluid in the capillary device of the present disclosure may be effectively conducted, thereby improving the overall performance of the capillary device.

In some embodiments, a capillary device is provided. The capillary device includes a first element, a second element, and a connecting structure. The first element includes a first supporting layer and a first capillary structure disposed on the first supporting layer and including a first metal material. The second element includes a second supporting layer and a second capillary structure disposed on the second supporting layer and including a second metal material. The connecting structure is disposed on the interface between the first capillary structure and the second capillary structure, connects the first capillary structure and the second capillary structure, and includes a connecting material. The connecting material is different from the first metal material and the second metal material.

In some embodiments, a method for forming a capillary device is provided. The method includes providing a first element. Wherein, the first element includes a first supporting layer and a first capillary structure disposed on the first supporting layer and including a first metal material. The method further includes providing a second element. Wherein, the second element includes a second supporting layer and a second capillary structure disposed on the second supporting layer and including a second metal material. The method further includes disposing a connecting element on the interface between the first capillary structure and the second capillary structure. The method further includes performing a thermal process on the connecting element to form a connecting structure connecting the first capillary structure and the second capillary structure. Wherein, the connecting structure includes a connecting material, and the connecting material is different from the first metal material and the second metal material.

The capillary device and the formation method thereof of the present disclosure may be applied in various types of capillary apparatus. In order to make the features and advantages of some embodiments of the present disclosure more understand, some embodiments of the present disclosure are listed below in conjunction with the accompanying drawings, and are described in detail as follows.

### BRIEF DESCRIPTION OF THE DRAWINGS

The present disclosure can be more fully understood from the following detailed description when read in conjunction with the accompanying drawings. It should be noted that, according to the standard practice in the industry, the various features are not drawn to scale. In fact, the dimensions of the various features may be arbitrarily increased or reduced for clarity.

FIG. 1 and FIG. 2 are schematic cross-sectional views showing different stages of a method for forming a capillary device according to an embodiment of the present disclosure, respectively.

FIG. 3 is a schematic cross-sectional view of a capillary device according to an embodiment of the present disclosure.

FIG. 4 and FIG. 5 are schematic cross-sectional views showing different stages of a method for forming a capillary device according to an embodiment of the present disclosure, respectively.

FIG. 6 is a schematic cross-sectional view of a capillary device according to an embodiment of the present disclosure.

FIG. 7 is a schematic cross-sectional view of a capillary device according to an embodiment of the present disclosure.

### DETAILED DESCRIPTION

Capillary devices of various embodiments of the present disclosure will be described in detail below. It should be understood that the following description provides many different embodiments for implementing various aspects of some embodiments of the present disclosure. The specific elements and arrangements described below are merely to clearly describe some embodiments of the present disclosure. Of course, these are only used as examples rather than limitations of the present disclosure. Furthermore, similar or corresponding reference numerals may be used in different embodiments to designate similar or corresponding elements in order to clearly describe the present disclosure. However, the use of these similar or corresponding reference numerals is only for the purpose of simply and clearly description of some embodiments of the present disclosure, and does not imply any correlation between the different embodiments or structures discussed.

In addition, it should be understood that ordinal numbers such as “first”, “second”, and the like used in the description and claims are used to modify elements and are not intended to imply and represent the element(s) have any previous ordinal numbers, and do not represent the order of a certain element and another element, or the order of the manufacturing method, and the use of these ordinal numbers is only used to clearly distinguished an element with a certain name and another element with the same name. The claims and the specification may not use the same terms, for example, a first element in the specification may be a second element in the claim.

Herein, the terms “approximately”, “about”, and “substantially” generally mean within 10%, within 5%, within 3%, within 2%, within 1%, or within 0.5% of a given value or range. The given value is an approximate value, that is, “approximately”, “about”, and “substantially” can still be implied without the specific description of “approximately”, “about”, and “substantially”. The term “a range between a first value and a second value”, “ranging from a first value to a second value”, or “a first value˜a second value” means that the range includes the first value, the second value, and other values in between. Furthermore, any two values or directions used for comparison may have certain tolerance.

In the following description and claims, terms such as “including”, “containing”, and “having” are open-ended words, so they should be interpreted as meaning “including but not limited to . . . ”. Therefore, when the terms “including”, “containing”, and/or “having” is used in the description of the present disclosure, it designates the presence of corresponding features, regions, steps, operations, and/or elements, but does not exclude the presence of one or more corresponding features, regions, steps, operations, and/or elements. Unless otherwise defined, all terms (including technical and scientific terms) used herein have the same meaning as commonly understood by a person of ordinary skills in the art. It is understood that these terms, such as those defined in commonly used dictionaries, should be interpreted as having meanings consistent with the relevant art and the background or context of the present disclosure, and should not be interpreted in an idealized or overly formal manner, unless otherwise defined in the embodiments of the present disclosure. Herein, the term “capillary function” refers to the performance that enables the existence of capillary phenomena, such as the flow rate of the working fluid, the water return effect of the working fluid, and the like.

In some embodiments, additional components may be added to the capillary device of the present disclosure. In some embodiments, some components of the capillary device of the present disclosure may be replaced or omitted. In some embodiments, additional operational steps may be provided before, during, and/or after the method of forming the capillary device. In some embodiments, some of the operational steps may be replaced or omitted, and the order of some of the operational steps is interchangeable. Furthermore, it should be understood that some of the operational steps may be replaced or deleted for other embodiments of the method. Furthermore, in the present disclosure, the number and size of each component in the drawings are only for illustration and are not used to limit the scope of the present disclosure.

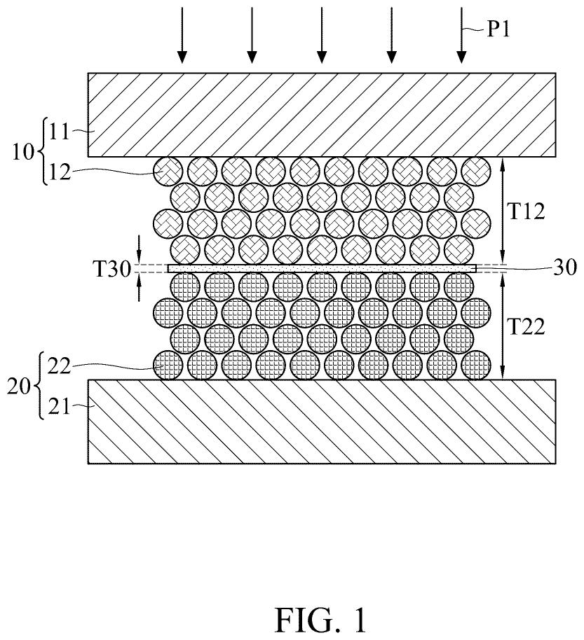

Referring to FIG. 1, which is a schematic cross-sectional view showing a stage of a method for forming a capillary device 1 according to an embodiment of the present disclosure. In some embodiments, a first element 10 may be provided. The first element 10 may be a capillary element having a capillary function. In some embodiments, the first element 10 may include a first supporting layer 11 and a first capillary structure 12. In some embodiments, the first supporting layer 11 may include glass, metal, ceramic, polymer, the like, or a combination thereof, but the present disclosure is not limited thereto. In some embodiments, the metal may include copper (Cu), tin (Sn), gold (Au), silver (Ag), nickel (Ni), indium (In), platinum (Pt), palladium (Pd), iridium (Ir), titanium (Ti), chromium (Cr), tungsten (W), aluminum (Al), molybdenum (Mo), titanium (Ti), magnesium (Mg), zinc (Zn), their alloys or compounds, the like, or a combination thereof.

As shown in FIG. 1, in some embodiments, the first capillary structure 12 may be disposed on the first supporting layer 11. In some embodiments, the first capillary structure 12 may be disposed on at least a portion or the entirety of the bottom surface of the first supporting layer 11. In some embodiments, the first capillary structure 12 may expose the bottom surface of the first supporting layer 11 or may not expose the bottom surface of the first supporting layer 11. In some embodiments, the first capillary structure 12 may include or may be a first metal material M1. In some embodiments, the first metal material M1 may be a material including metal. In some embodiments, the first metal material M1 may include copper, tin, gold, silver, nickel, indium, platinum, palladium, iridium, titanium, chromium, tungsten, aluminum, molybdenum, titanium, magnesium, zinc, their alloys or compounds, the like, or a combination thereof. In some embodiments, the first metal material M1 may further include non-metallic elements, for example, phosphorus, silicon, and the like.

As shown in FIG. 1, in some embodiments, a second element 20 may be provided. The second element 20 may be a capillary element having a capillary function. In some embodiments, the first element 10 and the second element 20 may be the same or different. In some embodiments, the second element 20 may include a second supporting layer 21 and a second capillary structure 22. In some embodiments, the material of the second supporting layer 21 may be the same as or different from the material of the first supporting layer 11. In some embodiments, the second supporting layer 21 may include glass, metal, ceramic, polymer, the like, or a combination thereof, but the present disclosure is not limited thereto. In some embodiments, the metal may include copper, tin, gold, silver, nickel, indium, platinum, palladium, iridium, titanium, chromium, tungsten, aluminum, molybdenum, titanium, magnesium, zinc, their alloys or compounds, the like, or a combination thereof.

As shown in FIG. 1, in some embodiments, the second capillary structure 22 may be disposed on the second supporting layer 21. In some embodiments, the second capillary structure 22 may be disposed on at least a portion or the entirety of the top surface of the second supporting layer 21. In some embodiments, the second capillary structure 22 may expose the top surface of the second supporting layer 21 or may not expose the top surface of the second supporting layer 21. In some embodiments, the second capillary structure 22 may include or may be a second metal material M2, and the second metal material M2 may be the same as or different from the first metal material M1. In some embodiments, the second metal material M2 may be a material including metal. In some embodiments, the second metal material M2 may include copper, tin, gold, silver, nickel, indium, platinum, palladium, iridium, titanium, chromium, tungsten, aluminum, molybdenum, titanium, magnesium, zinc, their alloys or compounds, the like, or a combination thereof. In some embodiments, the second metal material M2 may further include non-metallic elements, for example, phosphorus, silicon, and the like. In some embodiments, the first capillary structure 12 of the first element 10 may be disposed toward the second capillary structure 22 of the second element 20. In some embodiments, the first capillary structure 12 may be disposed between the first supporting layer 11 and the second capillary structure 22. In some embodiments, the second capillary structure 22 may be disposed between the first capillary structure 12 and the second supporting layer 21.

As shown in FIG. 1, in some embodiments, a connecting element 30 may be disposed on an interface between the first capillary structure 12 of the first element 10 and the second capillary structure 22 of the second element 20, and the connecting element 30 may be in contact with the first capillary structure 12 and the second capillary structure 22, respectively. In some embodiments, the first capillary structure 12 and the second capillary structure 22 may be disposed on opposite surfaces of the connecting element 30. In some embodiments, the connecting element 30 may be disposed on the first capillary structure 12 by painting, inserting, electroplating, sputtering, coating, surface modification, or a combination thereof. Next, the connecting element 30 is brought into contact with the second capillary structure 22. Therefore, the connecting element 30 may be located at the interface between the first capillary structure 12 and the second capillary structure 22. In some other embodiments, the connecting element 30 may be disposed on the second capillary structure 22, and then the connecting element 30 may be brought into contact with the first capillary structure 12.

As shown in FIG. 1, in some embodiments, the connecting element 30 may include or may be a third metal material M3. In some embodiments, the third metal material M3 may be a material including metal. In some embodiments, the third metal material M3 may be different from the first metal material M1, and the third metal material M3 may be different from the second metal material M2. In some embodiments, the third metal material M3 may include copper, tin, gold, silver, nickel, indium, platinum, palladium, iridium, titanium, chromium, tungsten, aluminum, molybdenum, titanium, magnesium, zinc, their alloys or compounds, the like, or a combination thereof, but the present disclosure is not limited thereto. In some embodiments, the third metal material M3 may further include non-metallic elements, for example, phosphorus, silicon, and the like. In some embodiments, the third metal material M3 may include copper, tin, silver, zinc, their alloys or compounds, the like, or a combination thereof.

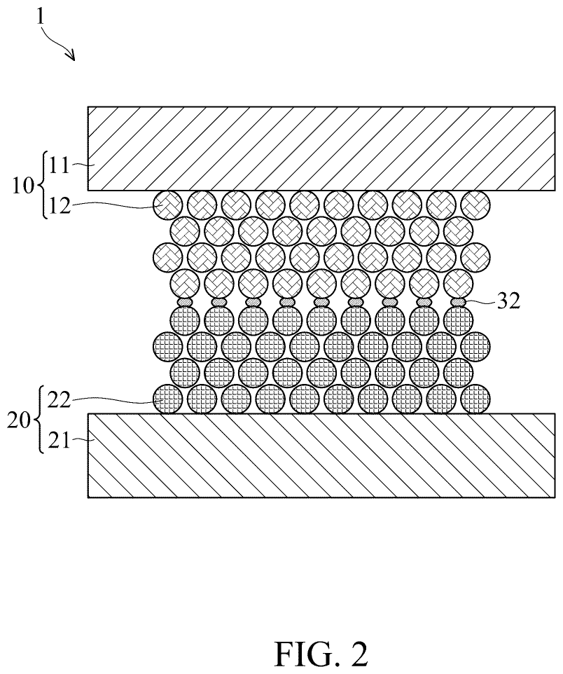

As shown in FIG. 1, in some embodiments, the melting point of the third metal material M3 may be lower than the melting point of the first metal material M1, and the melting point of the third metal material M3 may be lower than the melting point of the second metal material M2. In some embodiments, the melting point of the third metal material M3 of the connecting element 30 may be higher than or equal to 600° C., higher than or equal to 650° C., or higher than or equal to 700° C. In some embodiments, the melting point of the third metal material M3 may be lower than or equal to 850° C., lower than or equal to 800° C., or lower than or equal to 750° C. For example, the melting point of the third metal material M3 may be higher than or equal to 600° C. and lower than or equal to 850° C., higher than or equal to 650° C. and lower than or equal to 800° C., or higher than or equal to 700° C. and lower than or equal to 750° C. Accordingly, during the subsequent thermal process (for example, a thermal process P1), the connecting structure (for example, a connecting structure 32 in FIG. 2) may be formed without substantially destroying the first capillary structure 12 and the second capillary structure 22, thereby improving the overall performance of the capillary device.

As shown in FIG. 1, in some embodiments, in the normal direction of the first supporting layer 11 or the second supporting layer 21, the thickness T30 of the connecting element 30 may be 1 mm˜0.0001 mm, 0.05 mm˜0.005 mm, 0.02 mm˜0.008 mm, 1 mm˜0.001 mm, but the present disclosure is not limited thereto. For example, the thickness T30 of the connecting element 30 may be 1 mm, 0.5 mm, 0.1 mm, 0.05 mm, 0.02 mm, 0.01 mm, 0.008 mm, 0.005 mm, 0.001 mm, 0.0005 mm, 0.0001 mm, or any value or any range of values between the aforementioned values, but the present disclosure is not limited thereto. Accordingly, by adjusting the thickness T30 of the connecting element 30, the thickness of the subsequently formed connecting structure (for example, a connecting structure 32 in FIG. 2) may be adjusted, thereby improving the overall performance of the capillary device.

As shown in FIG. 1, in some embodiments, in the normal direction of the first supporting layer 11 or the second supporting layer 21, a ratio of the thickness T30 of the connecting element 30 and a thickness T12 of the first capillary structure 12 (the thickness T30 of the connecting element 30/the thickness T12 of the first capillary structure 12) is 0.01˜0.1, but the present disclosure is not limited thereto. For example, the ratio of the thickness T30 of the connecting element 30 to the thickness T12 of the first capillary structure 12 may be 0.01, 0.02, 0.03, 0.04, 0.05, 0.06, 0.07, 0.08, 0.09, or any value or any range of values between the aforementioned values, but the present disclosure is not limited thereto. In some embodiments, in the normal direction of the first supporting layer 11 or the second supporting layer 21, a ratio of the thickness T30 of the connecting element 30 and a thickness T22 of the second capillary structure 22 (the thickness T30 of the connecting element 30/the thickness T22 of the second capillary structure 22) may be 0.01˜0.1, but the present disclosure is not limited thereto. For example, the ratio of the thickness T30 of the connecting element 30 to the thickness T22 of the second capillary structure 22 may be 0.01, 0.02, 0.03, 0.04, 0.05, 0.06, 0.07, 0.08, 0.09, or any value or any range of values between the aforementioned values, but the present disclosure is not limited thereto. Accordingly, the thickness ratio of the first capillary structure 12, the second capillary structure 22, and the connecting structure (for example, a connecting structure 32 in FIG. 2) in the capillary device may be adjusted by adjusting the ratio of the thickness T30 of the connecting element 30 to the thickness T12 of the first capillary structure 12 or the ratio of the thickness T30 of the connecting element 30 to the thickness T22 of the second capillary structure 22, thereby improving the overall performance of the capillary device.

As shown in FIG. 1, in some embodiments, the connecting element 30 may be a brazing flux, solder paste, solder, filler, coating, plating, solder sheet, foil, powder, surface treatment agent, or a combination thereof, but the present disclosure is not limited thereto.

In some embodiments, when the connecting element 30 may be a brazing flux, solder paste, solder, or filler, the thickness T30 of the connecting element 30 may be 0.1 mm˜0.001 mm. For example, the thickness T30 of the connecting element 30 may be 0.1 mm, 0.09 mm, 0.08 mm, 0.07 mm, 0.06 mm, 0.05 mm, 0.04 mm, 0.03 mm, 0.02 mm, 0.01 mm, 0.009 mm, 0.008 mm, 0.007 mm, 0.006 mm, 0.005 mm, 0.004 mm, 0.003 mm, 0.002 mm, 0.001 mm, or any value or any range of values between the aforementioned values, but the present disclosure is not limited thereto. In these embodiments, the connecting element 30 may further include a matrix, and the third metal material M3 may be uniformly dispersed in the matrix. In some embodiments, the matrix may include solvents such as alcohols, ketones, alkanes, and the like. In some embodiments, a subsequent thermal process (for example, a thermal process P1) may vaporize the solvent, so as to remove the solvent. In some embodiments, the matrix may include a resin, such as a pyrolytic resin. In some embodiments, a subsequent thermal process (for example, a thermal process P1) may vaporize or burn the resin, so as to remove the resin.

In some embodiments, when the connecting element 30 may be a coating or a plating, the thickness T30 of the connecting element 30 may be 0.01 mm˜0.0001 mm. For example, the thickness T30 of the connecting element 30 may be 0.01 mm, 0.009 mm, 0.008 mm, 0.007 mm, 0.006 mm, 0.005 mm, 0.004 mm, 0.003 mm, 0.002 mm, 0.001 mm, 0.0009 mm, 0.0008 mm, 0.0007 mm, 0.0006 mm, 0.0005 mm, 0.0004 mm, 0.0003 mm, 0.0002 mm, 0.0001 mm, or any value or any range of values between the aforementioned values, but the present disclosure is not limited thereto. In these embodiments, the connecting element 30 may be made of (composed of) the third metal material M3. In other words, the connecting element 30 may include substantially no matrix, adjuvant, or auxiliary agent. For example, the connecting element 30 may be composed of metal. In these embodiments, the connecting element 30 may also include the aforementioned matrix, and the third metal material M3 may be uniformly dispersed in the matrix.

In some embodiments, when the connecting element 30 may be a solder sheet, foil, or powder, the thickness T30 of the connecting element 30 may be 0.1 mm˜0.001 mm. For example, the thickness T30 of the connecting element 30 may be 0.1 mm, 0.09 mm, 0.08 mm, 0.07 mm, 0.06 mm, 0.05 mm, 0.04 mm, 0.03 mm, 0.02 mm, 0.01 mm, 0.009 mm, 0.008 mm, 0.007 mm, 0.006 mm, 0.005 mm, 0.004 mm, 0.003 mm, 0.002 mm, 0.001 mm, or any value or any range of values between the aforementioned values, but the present disclosure is not limited thereto. In these embodiments, the connecting element 30 may be made of the third metal material M3. In other words, the connecting element 30 may include substantially no matrix, adjuvant, or auxiliary agent.

In some embodiments, when the connecting element 30 is a surface treatment agent, the thickness T30 of the connecting element 30 may be 0.01 mm˜0.0001 mm. For example, the thickness T30 of the connecting element 30 may be 0.01 mm, 0.009 mm, 0.008 mm, 0.007 mm, 0.006 mm, 0.005 mm, 0.004 mm, 0.003 mm, 0.002 mm, 0.001 mm, 0.0009 mm, 0.0008 mm, 0.0007 mm, 0.0006 mm, 0.0005 mm, 0.0004 mm, 0.0003 mm, 0.0002 mm, 0.0001 mm, or any value or any range of values between the aforementioned values, but the present disclosure is not limited thereto. In these embodiments, the connecting element 30 may further include a matrix, and the third metal material M3 may be uniformly dispersed in the matrix. For example, the connecting element 30 may be composed of metal.

As shown in FIG. 1, in some embodiments, after disposing the connecting element 30 on the interface between the first capillary structure 12 and the second capillary structure 22, a thermal process P1 is performed on the connecting element 30 to form a connecting structure 32 connecting the first capillary structure 12 and the second capillary structure 22. In some embodiments, the thermal process P1 may be heating, sintering, baking, other suitable thermal processes, or a combination thereof, but the present disclosure is not limited thereto. In some embodiments, the temperature of the thermal process P1 may correspond to the melting point of the third metal material M3. In some embodiments, the temperature of the thermal process P1 may be higher than or equal to the melting point of the third metal material M3. In some embodiments, the temperature of the thermal process P1 may be lower than the melting point of the first metal material M1, and the temperature of the thermal process P1 may be lower than the melting point of the second metal material M2. In some embodiments, the temperature of the thermal process P1 may be higher than or equal to 600° C. and lower than or equal to 850° C., higher than or equal to 650° C. and lower than or equal to 800° C., higher than or equal to 700° C. and lower than or equal to 750° C. Accordingly, during the thermal process P1, the first capillary structure 12 and the second capillary structure 22 may not be substantially damaged, so as to improve the overall performance of the capillary device.

Referring to FIG. 2, which is a schematic cross-sectional view showing a stage of a method for forming a capillary device 1 according to an embodiment of the present disclosure. In some embodiments, the capillary device 1 may be obtained after performing the thermal process P1 in a first period and a first temperature range. In some embodiments, the connecting structure 32 may be disposed on the interface between the first capillary structure 12 and the second capillary structure 22. In some embodiments, the connecting structure 32 may connect the first capillary structure 12 and the second capillary structure 22 and include a connecting material M3′. Since the connecting structure 32 is formed by performing the thermal process P1 on the connecting element 30 including the third metal material M3, the connecting structure 32 may include the connecting material M3′ which is different from the first metal material M1 and the second metal material M2.

In some embodiments, the connecting material M3′ of the connecting structure 32 may be substantially the same as the third metal material M3. In other words, it may be considered that the third metal material M3 does not substantially diffuse into the first metal material M1 and the second metal material M2, and the first metal material M1 and the second metal material M2 do not diffuse into the third metal material M3. In some embodiments, when the execution period of the thermal process P1 is shorter and/or the execution temperature is lower, the atoms in the first metal material M1, the second metal material M2, and the third metal material M3 are less likely to diffusion with each other (for example, the first metal material M1 is not easy to diffuse downward into the third metal material M3, the third metal material M3 is not easy to diffuse upward into the first metal material M1, the second metal material M2 is not easy to diffuse upward into the third metal material M3, and the third metal material M3 is not easy to diffuse downward into the first metal material M1), so that the connecting material M3′ is substantially the third metal material M3.

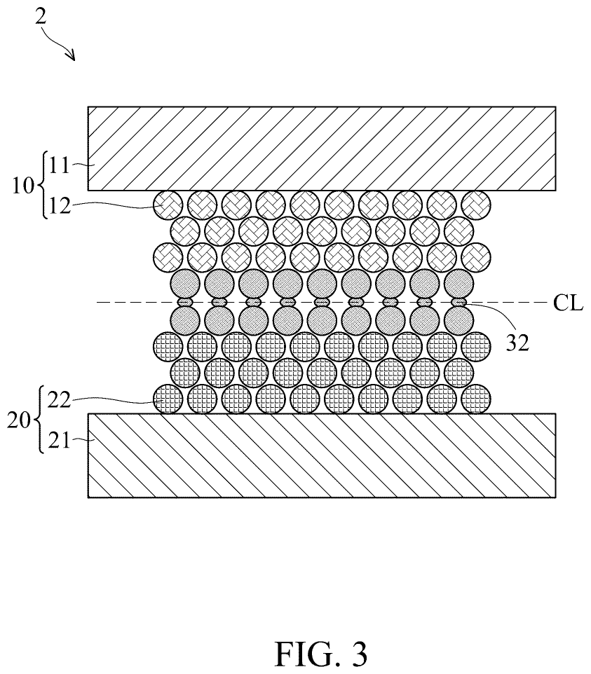

Referring to FIG. 3, which shows a schematic cross-sectional view of a capillary device 2 according to an embodiment of the present disclosure. In some embodiments, the capillary device 2 may be obtained after performing the thermal process P1 for a second period that is longer than the first period and/or at a second temperature range that is higher than the first temperature range. In some embodiments, the connecting material M3′ may be an alloy consisting of (composed of) the first metal material M1, the second metal material M2, and the third metal material M3. In other words, it can be considered that atoms in the first metal material M1, the second metal material M2, and the third metal material M3 diffuse into each other. In some embodiments, when the execution period and/or the execution temperature of the thermal process P1 is higher, the atoms in the first metal material M1, the second metal material M2, and the third metal material M3 are more likely to diffuse into each other. The connecting material M3′ is an alloy consisting of the first metal material M1, the second metal material M2, and the third metal material M3. In some embodiments, the closer to the central axis CL of the connecting structure 32, the higher the concentration of the third metal material M3. That is, the concentration of the third metal material M3 close to the central axis CL of the connecting structure 32 is higher than the concentration of the third metal material M3 far from the central axis CL of the connecting structure 32.

As shown in FIGS. 2 and 3, in some embodiments, each of the first capillary structure 12, the second capillary structure 22, and the connecting structure 32 may have the capillary function. For example, the working fluid may be transmitted through each of the first capillary structure 12, the second capillary structure 22, and the connecting structure 32. In some embodiments, the first capillary structure 12 and the second capillary structure 22 may include porous structures, and the connecting structure 32 may be a dot-shaped structure similar to a connection point. In some other embodiments, each of the first capillary structure 12, the second capillary structure 22, and the connecting structure 32 may include a porous structure. In some embodiments, the working fluid of the capillary device may include water, an organic solvent, a polymer, or a combination thereof. For example, the working fluid may be water.

Accordingly, since the capillary device of the present disclosure includes the connecting structure 32 connecting the first capillary structure 12 and the second capillary structure 22, the capillary function of the first capillary structure 12 and the second capillary structure 22 may be maintained while the first capillary structure 12 and the second capillary structure 22 are connected to each other. For example, since the connecting structure 32 itself is a dot-shaped structure or also has a capillary function, it is possible to avoid the generation of a discontinuous region between the first capillary structure 12 and the second capillary structure 22. For example, since the connecting structure 32 may physically connect (for example, by forming an alloy) the first capillary structure 12 and the second capillary structure 22 tightly, the bonding between the first capillary structure 12 and the second capillary structure 22 may be improved. For example, since the connecting structure 32 may connect the first capillary structure 12 and the second capillary structure 22 by performing the thermal process P1, the problem of deformation of the first capillary structure 12 and the second capillary structure 22 due to external force and loss of capillary function occurred in the process of directly connecting the first capillary structure 12 and the second capillary structure 22 may be avoided.

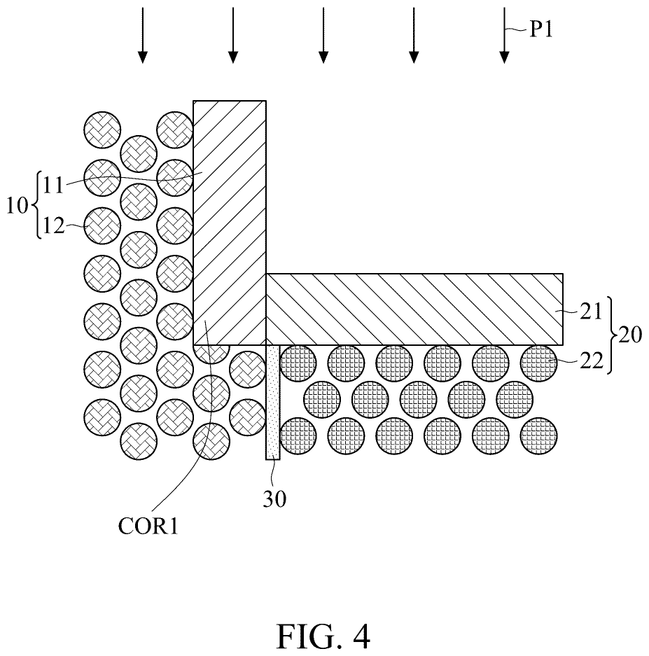

Referring to FIG. 4, which is a schematic cross-sectional view showing a stage of a method for forming a capillary device 3 according to an embodiment of the present disclosure. In some embodiments, the first capillary structure 12 may be disposed at a corner COR1 of the first supporting layer 11 to enhance the capillary function at the corner COR1. In some embodiments, the first capillary structure 12 may be disposed on the side surface and the bottom surface of the first supporting layer 11, but the present disclosure is not limited thereto. In some embodiments, the first supporting layer 11 may be in direct contact with the second supporting layer 21. In some embodiments, the extension direction of the first supporting layer 11 may be perpendicular to the extension direction of the second supporting layer 21. In some embodiments, the first capillary structure 12 may be a vertical capillary structure, and the second capillary structure 22 may be a horizontal capillary structure. In some embodiments, the connecting element 30 may be disposed on the interface between the first capillary structure 12 and the second capillary structure 22. In some embodiments, the connecting element 30 may be disposed below the interface between the first supporting layer 11 and the second supporting layer 21. In some embodiments, the aforementioned thermal process P1 may be performed.

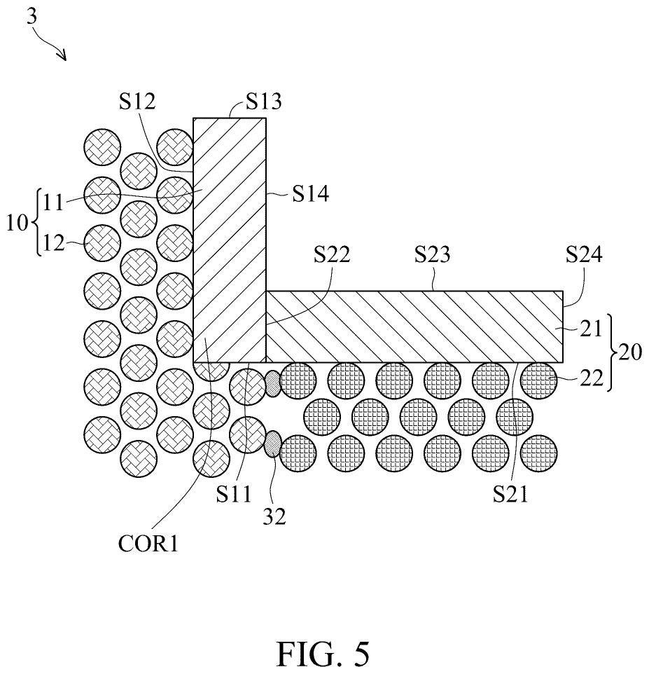

Referring to FIG. 5, which is a schematic cross-sectional view showing a stage of a method for forming a capillary device 3 according to an embodiment of the present disclosure. In some embodiments, the capillary device 3 may be obtained after performing the thermal process P1 in a third period and a third temperature range. In some embodiments, the capillary device 3 may include capillary structures extending in different directions. Accordingly, the connecting structure 32 may physically connect (for example, by forming an alloy) the first capillary structure 12 and the second capillary structure 22 tightly, and the first capillary structure 12 may be disposed at the corner COR1 of the first supporting layer 11. Therefore, the bonding between the vertical first capillary structure 12 and the horizontal second capillary structure 22 may be improved.

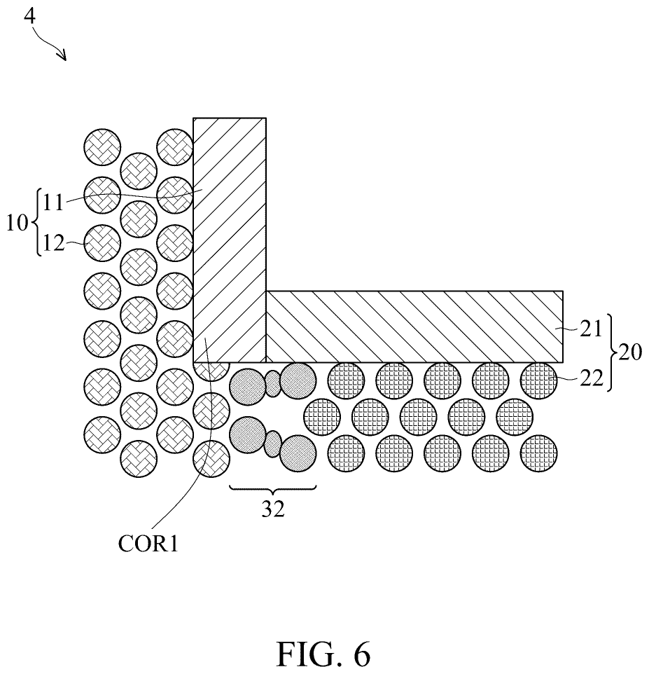

Referring to FIG. 6, which shows a schematic cross-sectional view of a capillary device 4 according to an embodiment of the present disclosure. In some embodiments, the capillary device 4 may be obtained after performing the thermal process P1 for a fourth period that is longer than the third period and/or at a fourth temperature range that is higher than the third temperature range. In some embodiments, the connecting structure 32 may be disposed on the interface between the first supporting layer 11 and the second supporting layer 21, and the connecting structure 32 may be further disposed on the first supporting layer 11 and the second supporting layer 21. In some embodiments, the connecting structure 32 may be disposed on the first supporting layer 11, cross the interface between the first supporting layer 11 and the second supporting layer 21, and extend onto the second supporting layer 21. In other words, the total area of the first supporting layer 11 and the second supporting layer 21 covered by the connecting structure 32 of the capillary device 4 may be larger than the total area of the first supporting layer 11 and the second supporting layer 21 covered by the connecting structure 32 of the capillary device 3. In some embodiments, the connecting structure 32 may cover at least 40%, 50%, 60%, or more of the bottom surface of the first supporting layer 11. Accordingly, the bonding effect may be improved.

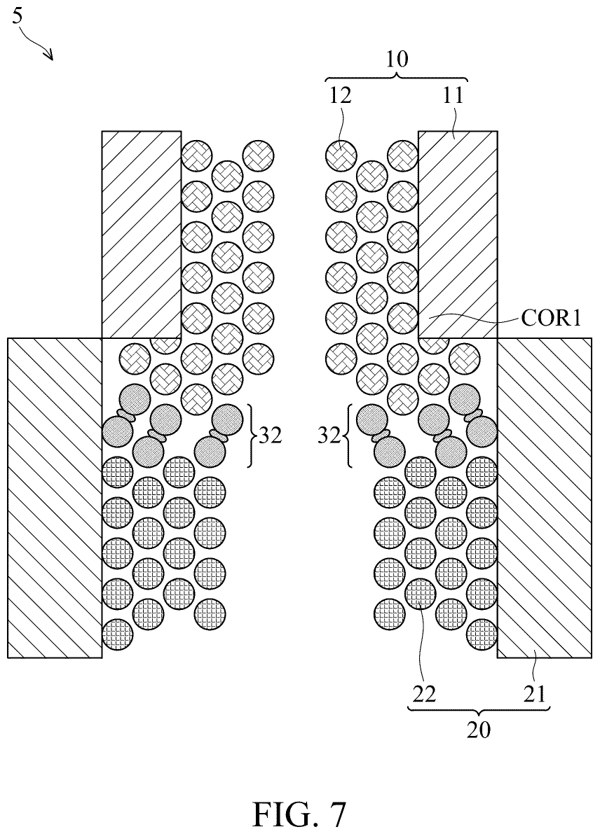

Referring to FIG. 7, which shows a schematic cross-sectional view of a capillary device 5 according to an embodiment of the present disclosure. In some embodiments, the first supporting layer 11 may be in direct contact with the second supporting layer 21. In some embodiments, the extension direction of the first supporting layer 11 may be the same as the extension direction of the second supporting layer 21. In some embodiments, the first capillary structure 12 and the second capillary structure 22 may both be vertical capillary structures, but the present disclosure is not limited thereto. In some other embodiments (not shown), the first capillary structure 12 and the second capillary structure 22 may both be horizontal capillary structures. In some embodiments, the capillary device 5 may include capillary structures extending in the same direction. For example, the first capillary structure 12 and the second capillary structure 22 may be capillary structures with the same extension direction and different tube diameters. In some embodiments, the connecting structure 32 and the second capillary structure 22 may be disposed on the same side of the second supporting layer 21. Accordingly, since the connecting structure 32 may physically connect (for example, by forming an alloy) the first capillary structure 12 and the second capillary structure 22 tightly, and the first capillary structure 12 may be disposed at the corner COR1 of the first supporting layer 11, thus improving the bonding effect.

Tables 1 to 4 show different examples (EX.) of the present disclosure.

TABLE 1

| | first | second | third | | concentration |
|---|---|---|---|---|---|
| | metal | metal | metal | connecting | gradient of |
| | material | material | material | material | connecting |
| Ex. | M1 | M2 | M3 | M3′ | material M3′ |
| 1 | Cu | Cu | Ag | Ag | not applicable |
| 2 | Cu | Cu | Ag | CuAg | Cu 99.9~0.1 atom % |
| | | | | alloy | Ag 0.1~99.9 atom % |
| | | | | | for example: |
| | | | | | Cu 99.9~90atom % |
| | | | | | Ag 0.1~10 atom % |
| 3 | Cu | Cu | Sn | Sn | not applicable |
| 4 | Cu | Cu | Sn | CuSn | Cu 99.9~0.1 atom % |
| | | | | alloy | Sn 0.1~99.9 atom % |
| | | | | | for example: |
| | | | | | Cu 99.9~90atom % |
| | | | | | Sn 0.1~10 atom % |
| 5 | Cu | Cu | Zn | Zn | not applicable |
| 6 | Cu | Cu | Zn | CuZn | Cu 99.9~0.1 atom % |
| | | | | alloy | Zn 0.1~99.9 atom % |
| | | | | | for example: |
| | | | | | Cu 99.9~90atom % |
| | | | | | Zn 0.1~10 atom % |

In Table 1, the term “not applicable” means that the first metal material M1, the second metal material M2, and the third metal material M3 are considered not to diffuse substantially with each other. The concentration gradient of the connecting material M3′ may be concentration from the edge of the connecting structure 32 to the central axis CL. Wherein, the copper-tin (CuSn) alloy may be bronze powder.

In Examples 1 and 2, since the third metal material M3 (Ag) has good compatibility with the first metal material M1 (Cu) and the second metal material M2 (Cu), a good connection effect may be achieved. In addition, since the third metal material M3 is silver with good thermal conductivity, it is advantageous for application in heat dissipation device. Furthermore, since silver has good hydrophilicity, it can improve the mobility of a working fluid such as water in the capillary device. In Examples 3 and 4, since the third metal material M3 is tin, the thermal conductivity is good. Moreover, in Examples 1 to 4, the thermal conductivity effects are ranked as follows: Example 1 is better than Example 2, Example 2 is better than Example 4, and Example 4 is better than Example 3. In Examples 5 and 6, since the third metal material M3 is zinc, it has a corrosion resistance effect similar to that of brass.

TABLE 2

| | first | second | third | | concentration |
|---|---|---|---|---|---|
| | metal | metal | metal | connecting | gradient of |
| | material | material | material | material | connecting |
| EX. | M1 | M2 | M3 | M3′ | material M3′ |
| 7 | Cu | Cu | Cu alloy | Cu alloy | Cu 99.9~51 atom % |
| | | | (CuX) | (CuX) | X 0.1~49 atom % |
| | | | | | for example: |
| | | | | | Cu 99.9~90 atom % |
| | | | | | X 0.1~10 atom % |
| 8 | Cu | Cu | CuAg alloy | CuAg | Cu 99.9~20 atom % |
| | | | Ag 65~80 atom % | alloy | Ag 0.1~80 atom % |
| | | | Cu 35~20 atom % | | for example: |
| | | | for example: | | Cu 99.9~28 atom % |
| | | | Ag 72 atom % | | Ag 0.1~72 atom % |
| | | | Cu 28 atom % | | |
| 9 | Cu | Cu | CuAgSnP alloy | CuAgSnP | Cu 99.6~30 |
| | | | Wherein, | alloy | atom % |
| | | | total content of Cu, | | Ag 0.1~50 atom % |
| | | | Ag, and P: | | P 0.1~50 atom % |
| | | | 80.2 atom % | | Sn 0.1~15.6 |
| | | | Sn: 15.6 atom % | | atom % |
| | | | Ni 4.2 atom %; and | | Ni 0.1~4.2 atom % |
| | | | trace impurities | | |
| | | | such as lead (Pb), | | |
| | | | zinc (Zn), and | | |
| | | | sulfur (S) | | |
| 10 | Cu | Cu | CuSn alloy | CuSn | Cu 99.9~85 atom % |
| | | | Cu 85~99.9 atom % | alloy | Sn 0.1~15 atom % |
| | | | Sn 15~0.1 atom % | | for example: |
| | | | for example: | | Cu 99~98 atom % |
| | | | Cu 98~99 atom % | | Sn 1~2 atom % |
| | | | Sn 1~2 atom % | | |

In some embodiments, the third metal material M3 in Example 7 may be a copper alloy. In some embodiments, the copper alloy may include copper and further include nickel, iron, silicon, phosphorus, tin, silver, zinc, magnesium, or a combination thereof. The copper content in the copper alloy may be higher than or equal to 51, 55, 60, or 65 atom %, and the total content of the remaining elements may be less than or equal to 49, 45, 40, or 35 atom %. The copper alloy may be presented as CuX, and X may include Ni, Fe, Si, P, Sn, Ag, Zn, Mg, or a combination thereof.

In Example 7, the remaining elements in the third metal material M3 may be selected according to the requirements, thereby increasing the versatility of application of the capillary device. For example, when the copper alloy includes silver, it has good thermal conductivity and good hydrophilicity. For example, when the copper alloys include zinc, it has good corrosion resistant. In Examples 8 and 9, silver has good compatibility with copper, so the connection effect, thermal conductivity, and hydrophilicity are good. In Example 10, since the third metal material M3 is tin, the thermal conductivity is good.

TABLE 3

| | first | second | third | | concentration |
|---|---|---|---|---|---|
| | metal | metal | metal | connecting | gradient of |
| | material | material | material | material | connecting |
| EX. | M1 | M2 | M3 | M3′ | material M3′ |
| 11 | Cu | Cu alloy | Cu | Cu | not applicable |
| 12 | Cu | (CuX) | Cu | Cu alloy | Cu 51~99.9 atom % |
| | | | | (CuX) | X 49~0.1 atom % |
| | | | | | for example: |
| | | | | | Cu 90~99.9 atom % |
| | | | | | Ag 10~0.1 atom % |

In Example 11, the connecting material M3′ is copper, and it may be considered that the third metal material M3 does not substantially diffuse into the first metal material M1 and the second metal material M2. In Example 12, the connecting material M3′ is a copper alloy, which may be regarded as the metal X in the second metal material M2 diffused into the third metal material M3. In Examples 11 and 12, the third metal material M3 (copper) has good compatibility with the first metal material M1 (copper) and the second metal material M2 (copper in the copper alloy), and may achieve good connection effect. In addition, the remaining elements in the second metal material M2 may be selected according to the requirements, thereby increasing the versatility of application of the capillary device. For example, when the copper alloy includes silver, it has good thermal conductivity and good hydrophilicity. For example, when copper alloys include zinc, it has good corrosion resistant.

TABLE 4

| | first | second | third | | concentration |
|---|---|---|---|---|---|
| | metal | metal | metal | connecting | gradient of |
| | material | material | material | material | connecting |
| EX. | M1 | M2 | M3 | M3′ | material M3′ |
| 13 | Cu | Cu alloy | Ag | Ag | not applicable |
| 14 | Cu | (CuX) | Ag | when X does | Cu 99.8~51 atom % |
| | | | | not include | Ag 0.1~50 atom % |
| | | | | Ag, it is | X 0.1~49 atom % |
| | | | | CuAgX alloy | |
| 15 | Cu | | Sn | Sn | not applicable |
| 16 | Cu | | Sn | when X does | Cu 99.8~51 atom % |
| | | | | not include | Sn 0.1~50 atom % |
| | | | | Sn, it is | X 0.1~49 atom % |
| | | | | CuSnX alloy | |
| 17 | Cu | | Zn | Zn | not applicable |
| 18 | Cu | | Zn | when X does | Cu 99.8~51 atom % |
| | | | | not include | Zn 0.1~50 atom % |
| | | | | Zn, it is | X 0.1~49 atom % |
| | | | | CuZnX alloy | |

In Examples 14, 16, and 18, it is considered that the metal X in the second metal material M2 diffuses into the third metal material M3. In Examples 13 and 14, silver has good compatibility with copper, so the connection effect, thermal conductivity, and hydrophilicity are good. In Examples 15 and 16, since the third metal material M3 is tin, the thermal conductivity is good. In Examples 17 and 18, since the third metal material M3 is zinc, it has a corrosion resistance effect similar to that of brass.

In some embodiments, the connecting element may be solder, and the melting point of the solder may be higher than or equal to 700° C. In some embodiments, the solder may include the following commercial products: Silvaloy 051, 071, 202, 252, 299, 300, 351, 380, 401, 402, 403, 450, 502, 505, 541, 559, 580, 600, 604, 630, 650, 700, 716, 721, 750, 852; Premabraze 051, 127, 131, 180, 265, 399, 402, 407, 408, 409, 500, 540, 580, 616, 680, 700; Lithobraze 720, 925; LM 721 Grade 1; Fine Silver (BR999); Sil-Fos 15, 5, 2, 2M; Handy Flo 6; Handy Flo 100 Series, 200 Series, 600 Series; Fos Flo, Fos Flo 6; Hi-Temp 095, 080, 548, 720, 820, 910, 930, 932, 933; Easy-Flo 30, 35; OFHC certified copper; CDA 102, 110, 510, 521, 681; or Trimet 245, 259, 299.

In some embodiments, one or more of the capillary devices 1 to 5 may be applied to a heat dissipation device, and the heat dissipation device may be such as a vapor chamber, a heat conducting plate, a heat dissipation module, the like, or a combination thereof. For example, the vapor chamber may include a three-dimensional vapor chamber.

Accordingly, since the capillary device of the present disclosure may include a connecting structure, the first capillary structure and the second capillary structure may be effectively connected to conduct the working fluid in the capillary device. Specifically, since the connecting material of the connecting structure is different from the first metal material of the first capillary structure and the second metal material of the second capillary structure, it is benefited to form the connecting structure. For example, the melting point of the third metal material or the connecting material may be lower than those of the first metal material and the second metal material. For example, since the connecting structure is formed by the thermal process, it is possible to avoid problems such as pores, discontinuous surfaces, and deformation at the interface between the capillary structures. For example, since the setting position, material composition, and other parameters of the connecting structure may be adjusted according to the requirements, the applicability of the capillary device may be improved. Furthermore, since the formation method of the capillary device in the present disclosure may include performing the thermal process on the connecting element, the connecting structure including different components may be formed based on the diffusion principle according to different parameters of the thermal process. Therefore, the capillary device and the formation method thereof of the present disclosure may improve the overall performance of the capillary device, such as improving the transmission efficiency of the working fluid, the reliability, and/or the applicability of the capillary device.

The features among the various embodiments may be arbitrarily combined as long as they do not violate or conflict with the spirit of the disclosure. In addition, the scope of the present disclosure is not limited to the process, machine, manufacturing, material composition, device, method, and step in the specific embodiments described in the specification. A person of ordinary skill in the art will understand current and future processes, machine, manufacturing, material composition, device, method, and step from the content disclosed in some embodiments of the present disclosure, as long as the current or future processes, machine, manufacturing, material composition, device, method, and step performs substantially the same functions or obtain substantially the same results as the present disclosure. Therefore, the scope of the present disclosure includes the abovementioned process, machine, manufacturing, material composition, device, method, and steps. It is not necessary for any embodiment or claim of the present disclosure to achieve all of the objects, advantages, and/or features disclosed herein.

The foregoing outlines features of several embodiments of the present disclosure, so that a person of ordinary skill in the art may better understand the aspects of the present disclosure. A person of ordinary skill in the art should appreciate that the present disclosure may be readily used as a basis for designing or modifying other processes and structures for carrying out the same purposes and/or achieving the same advantages of the embodiments introduced herein. A person of ordinary skill in the art should also realize that such equivalent constructions do not depart from the spirit and scope of the present disclosure, and that they may make various changes, substitutions, and alterations herein without departing from the spirit and scope of the present disclosure.

What is claimed is:

1. A capillary device, comprising:
a first element, comprising:
a first supporting layer; and
a first capillary structure disposed on the first supporting layer and comprising a first metal material;
a second element, comprising:
a second supporting layer; and
a second capillary structure, disposed on the second supporting layer and comprising a second metal material; and
a connecting structure, disposed on an interface between the first capillary structure and the second capillary structure, connecting the first capillary structure and the second capillary structure, and comprising a connecting material,
wherein the connecting material is different from the first metal material and the second metal material.

2. The capillary device as claimed in claim 1, wherein the connecting material is an alloy comprising the first metal material and the second metal material.

3. The capillary device as claimed in claim 2, wherein the connecting material is an alloy composed of the first metal material, the second metal material, and a third metal material, and a concentration of the third metal material close to a central axis of the connecting structure is higher than a concentration of the third metal material far from the central axis of the connecting structure.

4. The capillary device as claimed in claim 1, wherein the first supporting layer is in direct contact with the second supporting layer.

5. The capillary device as claimed in claim 1, wherein the first capillary structure is disposed on a corner of the first supporting layer.

6. The capillary device as claimed in claim 1, wherein the first capillary structure is disposed on a bottom surface of the first supporting layer.

7. The capillary device as claimed in claim 6, wherein the second capillary structure is disposed on a top surface of the second supporting layer.

8. The capillary device as claimed in claim 7, wherein the first capillary structure is disposed between the first supporting layer and the second supporting layer.

9. The capillary device as claimed in claim 8, wherein the second capillary structure is disposed between the first supporting layer and the second supporting layer.

10. The capillary device as claimed in claim 1, wherein the first capillary structure and the second capillary structure comprise porous structures, and the connecting structure is a dot-shaped structure.

11. The capillary device as claimed in claim 1, wherein each of the first capillary structure, the second capillary structure, and the connecting structure comprises a porous structure.

12. A method for forming a capillary device, comprising:
providing a first element, wherein the first element comprises:
a first supporting layer; and
a first capillary structure disposed on the first supporting layer and comprising a first metal material;
providing a second element, wherein the second element comprises:
a second supporting layer; and
a second capillary structure disposed on the second supporting layer and comprising a second metal material;
disposing a connecting element on an interface between the first capillary structure and the second capillary structure; and
performing a thermal process on the connecting element to form a connecting structure connecting the first capillary structure and the second capillary structure,
wherein the connecting structure comprises a connecting material, and the connecting material is different from the first metal material and the second metal material.

13. The method as claimed in claim 12, wherein the connecting element comprises a third metal material, and the connecting material is the third metal material or an alloy composed of the first metal material, the second metal material, and the third metal material.

14. The method as claimed in claim 13, wherein a melting point of the third metal material is lower than a melting point of the first metal material and a melting point of the second metal material.

15. The method as claimed in claim 14, wherein a temperature of the thermal process is higher than or equal to the melting point of the third metal material.

16. The method as claimed in claim 15, wherein the temperature of the thermal process is lower than the melting point of the first metal material and the melting point of the second metal material.

17. The method as claimed in claim 14, wherein the melting point of the third metal material is higher than or equal to 600° C.

18. The method as claimed in claim 17, wherein the melting point of the third metal material is lower than or equal to 850° C.

19. The method as claimed in claim 13, wherein:
the connecting element further comprises a matrix, and the third metal material is dispersed in the matrix, and
the thermal process is performed on the connecting element to vaporize the matrix.

20. The method as claimed in claim 12, wherein the step of disposing the connecting element on the interface between the first capillary structure and the second capillary structure further comprises:
disposing the connecting element on the first capillary structure by painting, inserting, electroplating, sputtering, coating, surface modification, or a combination thereof; and
contacting the connecting element with the second capillary structure.
